(19) United States
(12) Patent Application Publication
(10) Pub. No.: US 2023/0019874 A1
(43) Pub. Date: Jan. 19, 2023

(54) SYSTEMS AND METHODS OF NEURAL NETWORK TRAINING

(71) Applicant: NINTENDO CO., LTD., Kyoto (JP)

(72) Inventors: Pierre Cordani, Nogent-Sur-Marne (FR); Alexandre Delattre, Viroflay (FR)

(21) Appl. No.: 17/374,034

(22) Filed: Jul. 13, 2021

(51) Int. Cl. G06N 3/08; G06T 3/40

(52) U.S. Cl. CPC G06N 3/08; G06T 3/4084

(57) ABSTRACT

A computer system is provided for training a neural network that converts images. Input images are applied to the neural network and a difference in image values is determined between predicted image data and target image data. A Fast Fourier Transform is taken of the difference. The neural network is trained on based the L1 Norm of resulting frequency data.

### CROSS REFERENCE(S) TO RELATED APPLICATION(S)

The entire contents of U.S. application Ser. Nos. 16/830,032 and 16/829,950, both filed Mar. 25, 2020, are incorporated by reference.

### TECHNICAL OVERVIEW

The technology described herein relates to machine learning and training machine learned models or systems. More particularly, the technology described includes subject matter that relates to training neural networks to convert or upscale images by using, for example, Fourier Transforms (FTs).

### INTRODUCTION

Machine learning can give computers the ability to “learn” a specific task without expressly programming the computer for that task. An example of machine learning systems includes deep learning neural networks. Such networks (and other forms of machine learning) can be used to, for example, help with automatically recognizing whether a cat is in a photograph. The learning takes place by using thousands or millions of photos to “train” the network (also called a model) to recognize when a cat is in a photograph. The training process can include, for example, determining weights for the model that achieve the indicated goal (e.g., identifying cats within a photo). The training process may include using a loss function in a way (e.g., via backpropagation) that seeks to train the model or neural network that will minimize the loss represented by the function. Different loss functions include L1 (Least Absolute Deviations) and L2 (Least Square Errors) loss functions.

It will be appreciated that new and improved techniques, systems, and processes are continually sought after in these areas of technology, such as technology that is used to train machine learned models or neural networks.

### SUMMARY

In some examples, computer system for training a neural network that processes images is provided. In some examples, the system is used to train neural networks to upscale images from one resolution to another resolution. The system may include computer storage that stores image data for a plurality of images. The system may be configured to generate, from the plurality of images, input image data and then apply the input image data to a neural network to generate predicted output image data. A difference between the predicted output image data and target image data is calculated and that difference may then be transformed in frequency domain data. In some examples, the L1-loss is then used on the frequency domain data calculated from the difference, which is then used to train the neural network using backpropagation (e.g., stochastic gradient descent). Using the L1 loss may encourage sparsity of the frequency domain data, which may also be referred to, or part of, Compressed Sensing. In contrast, using the L2 loss on the same frequency domain data may generally not produce in good results due to, for example, Parseval's Theorem. In other words, the L2 loss of frequency transformed data, using a Fourier Transform, is the same as the L2 loss of the data—i.e., L2(FFT(data))=L2(data). Thus, frequency transforming the data when using an L2 loss may not produce different results.

Trained neural networks may be deployed to computing systems that are used by users to play video games or other programs that generate images. The neural network may be used to convert images that are natively generated (e.g., by a rendering engine) into images of a higher resolution. In some examples, the upscaled or converted images may include Gibbs or ringing artifacts.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages will be better and more completely understood by referring to the following detailed description of example non-limiting illustrative embodiments in conjunction with the drawings of which:

FIG. 1 is a block diagram that includes an example computer system according to certain example embodiments;

FIG. 2 is a flow chart showing a machine learning process that may be executed on the computer system of FIG. 1;

FIG. 3 is a block diagram that includes an example computer system that uses trained neural networks to produce converted and/or upscaled images according to certain example embodiments;

FIG. 4A shows a lower resolution input image, in color, that may be used in connection with training a neural network with the computer system of FIG. 1 or using a neural network with the computer system of FIG. 3;

FIG. 4B shows a higher resolution predicted image, in color, produced by training without using a Fast Fourier Transform during training according to certain example embodiments;

FIG. 4C shows a higher resolution predicted image, in color, produced by training by using a Fast Fourier Transform during training of a neural network according to certain example embodiments;

FIG. 5 shows side-by-side views, in color, of a source image, a predicted image trained using the FFT of the L1 loss, and a predicted image trained using an L1 loss without FFT;

FIG. 6 is a graph of an example of learning rate scheduling for training a neural network according to certain example embodiments; and

FIG. 7 shows an example computing device that may be used in some embodiments to implement features described herein.

### DETAILED DESCRIPTION

In the following description, for purposes of explanation and non-limitation, specific details are set forth, such as particular nodes, functional elements, techniques, protocols, etc. in order to provide an understanding of the described technology. It will be apparent to one skilled in the art that other embodiments may be practiced apart from the specific details and examples described below. In certain instances, detailed descriptions of well-known methods, systems, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

Subject matter herein includes discussion of training neural networks to convert, upscale, or upconvert images. For example, the techniques discussed herein include techniques for training a neural network to covert images of one resolution (e.g., 540p, 720p, 1080p, etc.) to another, second, resolution (e.g., 720p, 1080p, 4k, etc.). Training of a neural network typically involves the use of a loss function. Typical loss functions may include the L1-norm loss function and the L2-norm loss function. As discussed in greater detail below, in certain examples embodiments, instead of using an L1-norm loss function (e.g., to minimize the sum of the absolute differences between a target value, H(x,y), and the estimated value, G(x,y)), a modified loss function that seeks to minimize the absolute value of the Fourier Transformed difference between H(x,y) and G(x,y) is used. Accordingly, the neural network training techniques discussed herein include those that seek to minimize the absolute value (e.g., the L1 loss) of the Fourier Transform of the difference between a generated signal (an image generated from a neural network) and a target signal (e.g., an upscaled image, which may be called a ground truth image and may be viewed as an ideal or expected result). The techniques discussed herein can be applied to training both convolutional neural networks and SBT (separable block transform) neural networks as discussed in the '950 application.

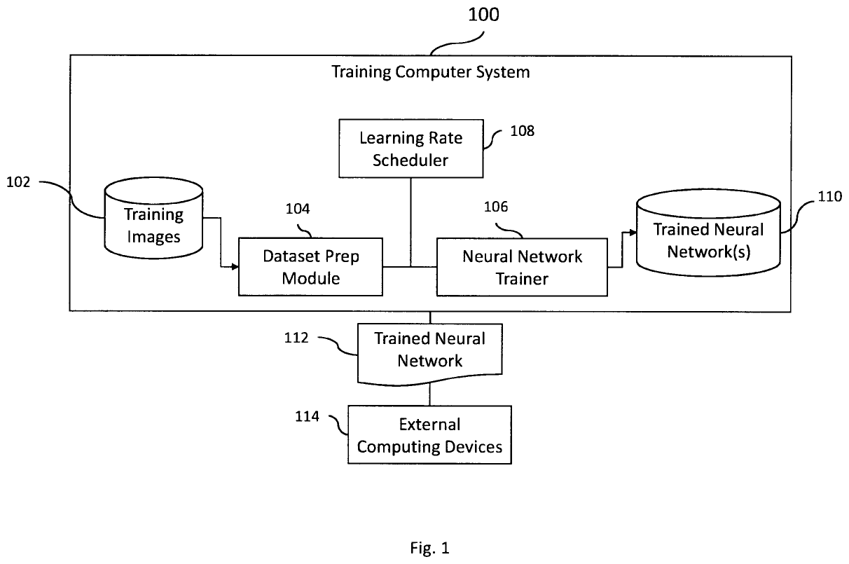

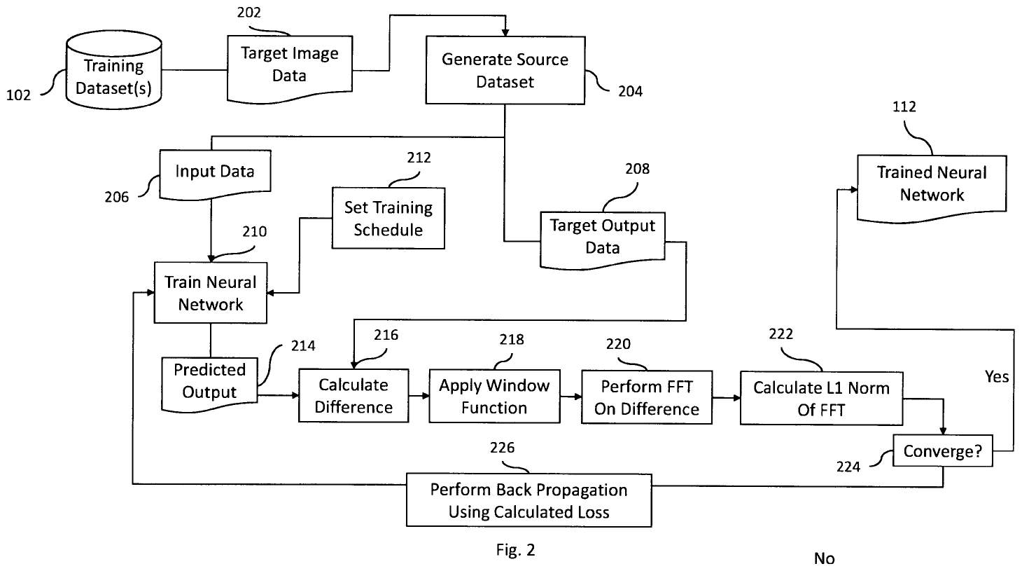

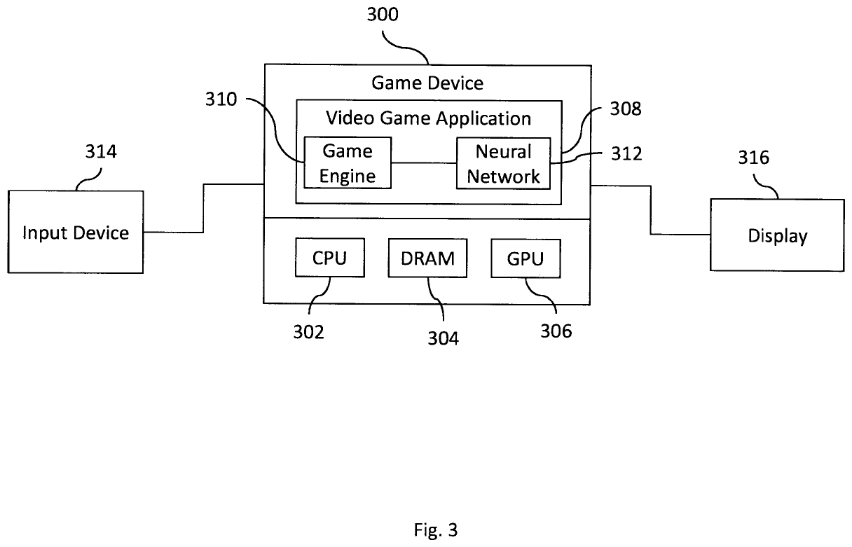

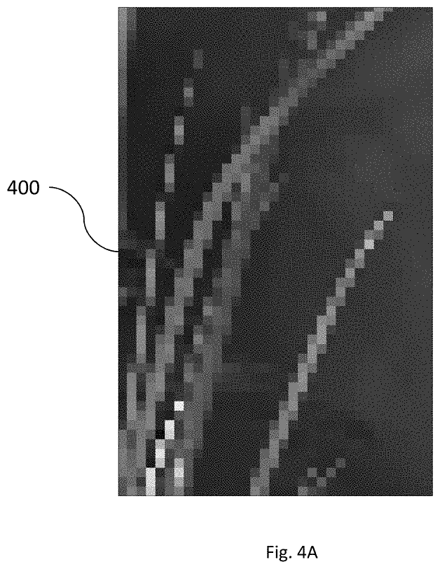

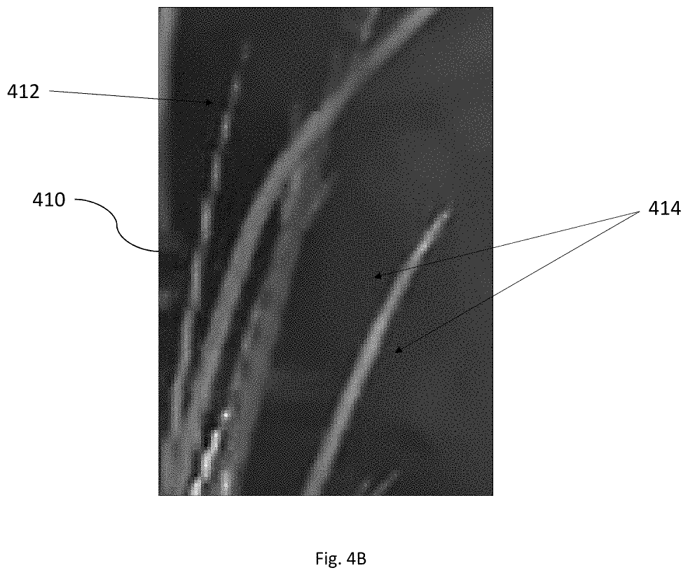

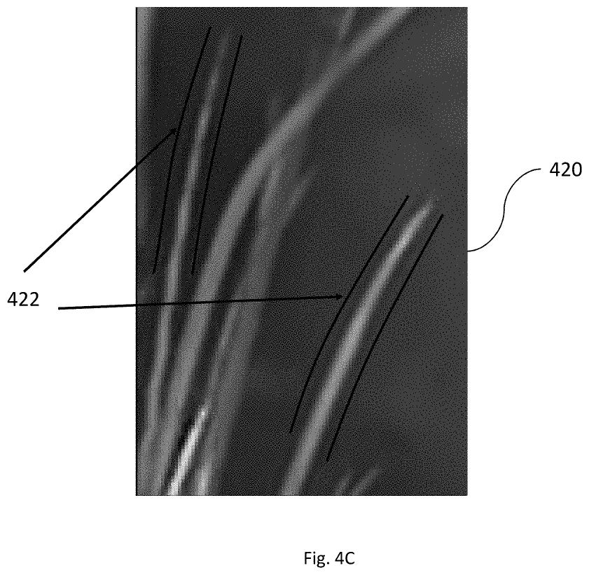

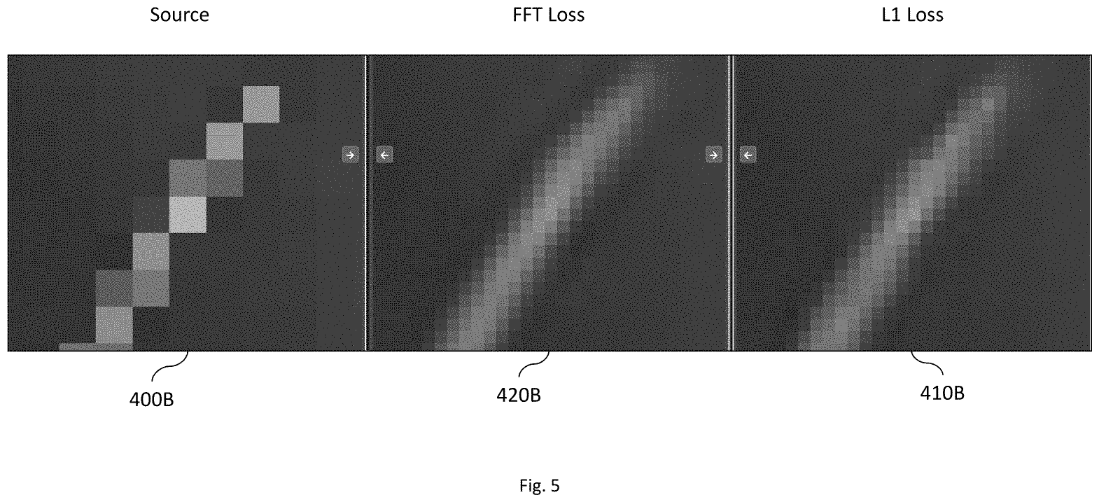

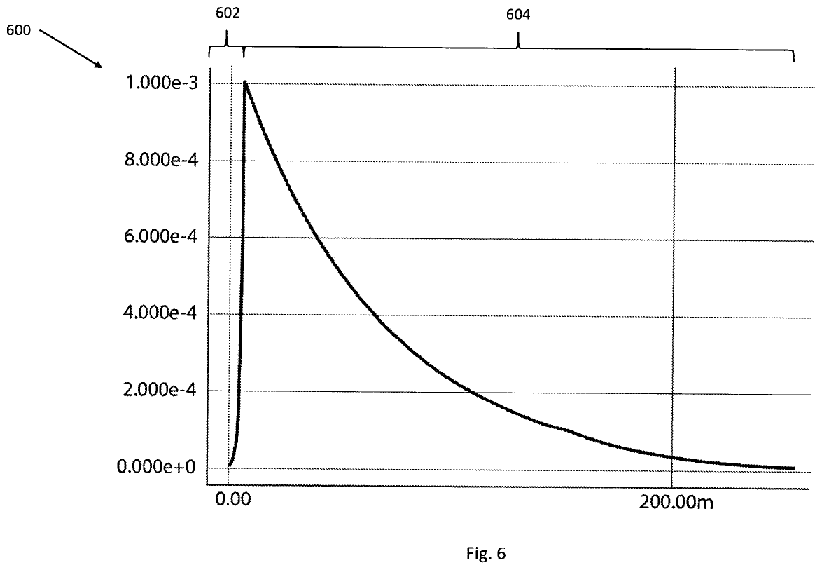

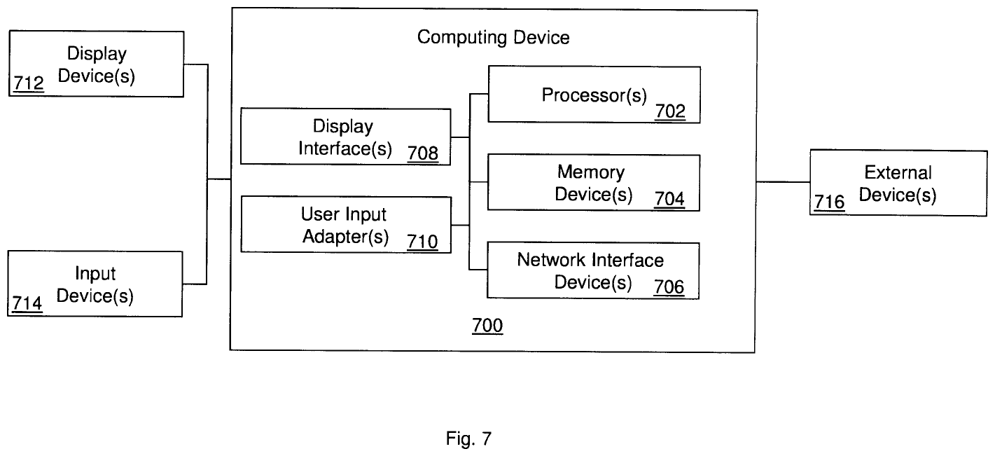

FIG. 1 shows an example computer system that is used to train neural networks. FIG. 2 shows an example process used by the system shown in FIG. 1. FIG. 3 shows an example computer system that uses neural networks trained using the process discussed in FIG. 2 to produce converted and/or upscaled images that are then displayed to a user. FIG. 4A shows an example low-resolution input image. FIG. 4B shows an example of an upconverted image generated from the image shown in FIG. 4A by using a neural network trained with a L1 loss function. FIG. 4C shows an example of an upconverted image generated from the image shown in FIG. 4A by using a neural network trained with a FFT loss function. FIG. 5 shows a side-by-side view of a source image, an image upconverted with a neural network trained with L1 loss, and an image upconverted with a neural network trained with an FFT loss. FIG. 6 shows an example of a learning rate schedule used for training a neural network when an FFT loss is used according to certain example embodiments. FIG. 7 is a block diagram of an example computer system that may be used in FIG. 1 or 3 and/or to implement or execute the process shown in FIG. 2.

In many places in this document, including but not limited to the description of FIGS. 1, 2, 3, and 7, software modules, software components, software engines, and/or actions performed by such elements are described. This is done for ease of description; and it should be understood that, whenever it is described in this document that a software module or the like performs any action, the action is in actuality performed by underlying hardware elements (such as a processor, hardware circuit, and/or a memory device) according to the instructions that comprise the software module or the like. Further details regarding this are provided below in, among other places, the description of FIG. 7.

### Description of FIG. 1

FIG. 1 is a block diagram that includes an example computer system 100 according to certain example embodiments. Computer system 100 uses training datasets (e.g., that are composed of many different images) to train neural networks that may then be distributed for use on other computing devices (e.g., game device 300). As discussed in greater detail below, the training of a neural network may use a loss function that includes taking, for example, the absolute value of the Fourier Transform of the difference between the predicted and target data. Accordingly, the training computer system 100 may determine, calculate, or transform the image data (or the resulting difference between image data) from one domain (e.g., spatial domain) into another domain (e.g., the frequency domain). In certain example embodiments, a Fast Fourier Transform (FFT) or other Fourier Transform may be used to transform the difference into a frequency representation. This representation may then be used to train the neural network.

Training computer system 100 includes a stored collection of training images 102 and a stored collection of trained neural networks 110. Each trained neural network 112 may be deployed or communicated to external computing devices 114. Also included in the training computer system 100 are a dataset preparation module 104, a learning rate scheduler 108, and a neural network trainer 106. Each of these components are discussed in further detail below.

Training computer system 100 is an example of computer system 700 that is shown in FIG. 7. An example of training computer system 100 may also be the training computer system 900 discussed in U.S. application Ser. No. 16/829,950 (the '950 Application herein). In certain examples, the functionality provided by computer system 100 may be similar to that provided by the computer system 900 of the '950 Application.

Training images 102 are stored to memory of the training computer system (e.g., memory devices 704) and may be stored in flat files, in a database, or the like. While images are discussed in connection with certain example embodiments herein, the techniques discussed herein for training neural networks may be applied to other types of data (e.g., audio, text, and other types of data). For example, the training data included in such databases may include training audio files, words, sentences, documents, or other types of data.

Training images 102 include images that are the “target” or goal for the neural network that is to be trained. An illustrative example of such a target image includes the target output data 208 that is discussed in greater detail in FIG. 2. In the case of training a neural network to upscale images to a higher resolution, training images 102 may include images that are in at target resolution. For example, if the neural network is to be trained to convert 540p images to 1080p images, then the training dataset may include images at a 1080p resolution. In certain example embodiments, training images 102 may also include the images or other data that the neural network will be training to achieve the target (e.g., the lower resolution images). For example, the images that are generated via the dataset preparation module 104 may be stored back with training images 102 and associated with the corresponding “target” images. Accordingly, an example database may include a list of tuples of <target image, input image> that are then used to train the neural network.

In certain example embodiments, the target images may be selected according to the particular use case for which the neural network is being trained. For example, in the case training a neural network to upscale images for video games, the images in the training dataset may be generated by one or more game engines (or other computing processes for generating such images) at the target resolution. In certain example embodiments, the images may be from the same game engine or game for which the neural network is being used (e.g., on game device 300). Thus, for example, game A may include a game engine (or functionality of a game engine) that has the ability to generate 1080p images. This may be beneficial because another version of game A may be produced that generates game images in 540p. This may be because, for example, the other version of game A is created for less powerful hardware (e.g., the game engine is using less powerful hardware to generate the game images for the video game). A mobile device or the like (e.g., operating on a battery) may be an example of hardware that is less powerful than a personal computer or in-home gaming console. As used herein, less powerful includes instances where the same hardware (e.g., the same game device) is operating at a lower power level (e.g., the memory and/or hardware processor of a computing device is operating at a lower clock frequency). For example, a portable device may turn down operating performance (decrease the clock frequency of one or more pieces of hardware) when operating on battery power as opposed to being plugged in. The same portable device may then operate at a higher performance level when plugged into dedicated power (e.g., via a wall power socket or the like). In any event, in certain instances, a game engine may be used to generate images for training dataset(s) that will be used to train a neural network that can be used in conjunction with executing game A (or other games in certain examples).

Dataset Preparation Module 104 is used to prepare data that will be used to train neural networks. Functionality of the Dataset Preparation Module 104 may include preparing the target or result images for the neural network training, preparing the source or input images for the neural network training, segmenting images (input and/or target) into smaller chunks (e.g., creating 64×64 pixel images from larger images that are part of training images 102), and/or generating lower resolution versions (e.g., input images) of the target images. In certain examples, Dataset Preparation Module 104 may include functionality for transforming the data of the images (input and/or target) into the frequency domain by using a Fourier Transform. It will be appreciated that the results of using the Dataset Preparation Module 104 may be stored back to a training database and then subsequently used at a later date for training a neural network.

Neural Network Trainer 106 is responsible for handling the training of neural networks. Neural Network Trainer 106 takes, as input, one or more prepared instances of input data (e.g., low resolution images) and trains (e.g., by using stochastic gradient descent) a neural network to come close to (e.g., converge with) the target data (e.g., higher resolution images).

Training a neural network may involve using one or more loss functions. In certain example embodiments, the loss function that is used during training seeks to minimize the absolute value of the Fourier Transformed difference between H(x,y) (image data for a target image) and G(x,y) (image data for a predicted image) is used. This example loss function is termed an FFT loss function (or FFT loss) herein. It will be appreciated that other loss functions or variations on such loss functions may be used in accordance with certain examples. For example, other losses may be combined with or used instead of the absolute difference. In certain examples, the frequency information of the images may be stored and used to train a neural network. In other words, the FFT of the images may be pre-calculated or the like and then used in the training as discussed herein.

Learning Rate Scheduler 108 operates in conjunction with the Neural Network Trainer 106 during the training process and is used to apply a learning rate schedule to the training of the neural network. In certain examples, this component controls a hyperparameter (e.g., a learning rate). In certain examples, the learning rate may be expressed as a real number between 0 and 1 (or a percentage between 0% and 100%). When a neural network is being trained (via the Neural Network Trainer 106) the error caused by each node in the neural network is estimated (e.g., via backpropagation). This error is used to adjust the weights for that node. The learning rate value acts as a damping effect on weight adjustments for the nodes of the neural network. For example, a learning rate hyper parameter set to 0.5 would cause an update of the weights based on 50% of the estimated error for that node. Over the training of a neural network, the learning rate parameter may be adjusted or otherwise controlled by the Learning Rate Scheduler 108. An example schedule for a learning rate over the course of training a neural network according to certain example embodiments is shown in FIG. 6. Schedules for learning rates may be stored to non-transitory storage and/or may be expressed via an equation.

Trained neural networks that are output from the neural network trainer 106 (e.g., those that have converged) are then stored into the trained neural networks data storage 110, which may be stored to non-transitory data storage, such as memory devices 704 in FIG. 7. Individual trained neural networks 112 may be distributed to external computing devices 114 for use thereon (e.g., to upscale or convert images). Examples of external computing devices 114 may include computing device 700 that is shown in FIG. 7. An example of external computing devices 114 may include game device 100 that is discussed in the '950 application and/or game device 300 that is discussed herein.

In certain examples, distribution of trained neural network(s) 112 to external computing devices 114 may be performed by loading the trained neural networks onto physical media (e.g., game cartridges, DVDs, etc.) and distributing such physical media to users of external computing devices 114. In certain examples, distribution may be accomplished by communicating the data for the trained neural networks via a network (e.g., the internet) to such external computing devices for use thereon.

In certain example embodiments, one or more trained neural networks may be delivered along with a game or other application program that is acquired by a user. For example, a user may download a game from an online repository (e.g., an online store) or the like and one of the components of the game may be a neural network for processing images produced by that game. The neural network that is acquired may have trained on images generated by that game or on images generated by other games (or other sources). In certain examples, neural networks may be downloaded or acquired separately from the game in which they are used. Similarly, games that are provided on cartridges or other physical media may include one or more neural networks that can be used by the user to transform images produced by the game. In certain examples, multiple neural networks may be provided for the same instance of a game (e.g., an individual download or specific physical media instance) to allow for the game to output to different types of displays (e.g., 1080p in one instance, 1440p in another, 4k in another, etc.) and/or under different processing conditions. For example, a powerful computer (e.g., with more powerful hardware components) may acquire a neural network that allows for game images rendered at 1080p to be upscaled to 4k. In another example, a less power computer (e.g., with less powerful hardware components than the above example) may acquire a neural network that allows for game images rendered at 540p to be upscaled to 1080p. Additional details of rendering and use of trained neural networks are provided in connection with FIG. 3 and in the '950 Application.

### Description of FIG. 2

FIG. 2 is a flow chart showing a machine learning process that may be executed on the computer system of FIG. 1.

A set of training images may be initially assembled to form a training dataset 102. From the training datasets 102, target image data 202 for training a neural network is selected. This may include selecting a plurality of target images or training images. In certain examples, a training dataset may be prepared with a certain number of images. For example, each training dataset may be 512,000 images. In certain example embodiments, the image data may be 64×64 pixel images (in certain examples the image size may be a power of 2) that have been selected from a larger image file. For example, if an original image is generated at 1080p, then that image may be split into 64×64 chunks or only select portions (e.g., one or more) of the larger image may be used in connection with preparing a training dataset.

As an example, in the case of training a neural network to upconvert to 1080p, the images may be a collection of 1080p images. In certain examples, when training a neural network to upconvert (or convert) images, the target images (e.g., the higher resolution images) may be those that are viewed as the ground truth and those that the neural network training process will seek to minimize the loss with respect to.

At 204, the target image data (e.g., target output data 208) is processed in order to generate the input dataset 206 that will be used as the input for the neural network training process. In the case of training a neural network to upconvert images, the target image data will be processed to create lower resolution image data. Illustrative examples of how such lower resolution image data may be created from target image data are discussed in U.S. application Ser. No. 16/829,950, however, other techniques for creating datasets for such images may also be used.

At 210, the training process of the neural network is started (or continues if returning from 224). In the case of the first iteration, the neural network may be randomized (e.g., the weights randomly set). In certain examples, a previously generated neural network may be used as a starting point. For example, a neural network trained with L1 loss (e.g., without using FFT).

At 212 the learning rate may be set or updated in accordance with a learning rate schedule. As noted above, the training of the neural network may be controlled according to a learning rate hyperparameter. The learning rate hyperparameter may be controlled and/or adjusted after a given number of epochs, after each epoch, after a given number of batches, or after a number of crops (or images) that are used to train the neural network. In certain examples, the hyperparameter may be controlled according to a loss curve over time. The learning rate for training a neural network can influence (e.g., sometimes significantly) on how the model is trained and/or whether it trained at all.

Controlling the learning rate may be conceptually similar to controlling heat transfer while blacksmithing. To little or too much can result in a poor end product. The same is true to training neural network and setting the learning rate. If the learning rate is too low, then the neural network may never converge. If it is too high, then the neural network may erratically change and have undesirable effect on the resulting network.

It will be appreciated that in certain examples herein (e.g., where the FFT information is used for training a neural network) that conventional learning rate scheduling techniques (including adaptive techniques) were observed by the inventors to not provide workable results in some instances. In other words, it was observed that using such conventional learning rate scheduling techniques could result in the neural network not properly converging during training.

An illustrative non-limiting example training schedule is shown in graph 600 of FIG. 6 and may include starting with a learning rate of 1^{e}−5 an incrementing exponentially each 512k images (e.g., crops of images) that are used. The exponential increase may be performed for 12 steps until the learning rate reaches on or about 1^{e}−3. After reaching this value, the learning rate may begin to be decreased (per 512k images seen) until again reaching a learning rate of 1^{e}−5. In certain example embodiments this may be a step decay schedule. For example, the learning rate may be halved every 10 epochs (e.g., with training 512k images being one epoch).

In certain examples, the learning rate that is set for training the neural network may include a first portion 602 in which the learning rates increases (e.g., exponentially, linearly, or otherwise) until a first threshold learning rate is reached. Then, the learning rate is controlled to decrease (e.g., exponentially, linearly, or otherwise) over a second portion 604. In certain examples, the absolute value of the rate of increase of the learning rate (e.g., during the first portion) is greater than the absolute value of the rate of decreasing the learning rate (e.g., during the second portion).

It will be appreciated that other learning rates and other variations of the learning rates shown in FIG. 6 are also possible and contemplated in connection with the techniques discussed herein. In certain example embodiments, adaptive learning rate techniques may be used. Examples of adaptive learning rate algorithms may include RMSprop, Adadelta, and Adam.

Returning to FIG. 2, the input data 206 is run through the neural network to generate predicted output data 214. For example, the predicted output data 214 may be a two dimensional array of pixel values (e.g., 128×128, assuming the training dataset includes 64×64 pixel images, for an upscale ratio of 2).

At 216, the difference between the target output data 208 (e.g., 128×128 pixel values) and predicted output data 214 (e.g., pixel values that correspond to the same location within the output data 208) is calculated. This produces another two dimensional array of pixel values that is the difference between the two pieces of image data (the generated or predicted image and the target image).

At 218, a windowing function is applied to the resulting two dimensional array of real values of the differences between the images. The windowing function varies by multiplying each value in the difference array between 0 and 1, where the number is based on the location of the value with the array. In certain example embodiments, the windowing function is used to damp down on the change that would be introduced at the edges of the array. In general, the values towards the center of the array will remain unchanged (e.g., multiplied by 1) while values at the edges of the difference array may be reduced to zero (or near zero) (e.g., by multiplying by 0 or near 0). In certain examples, this means that values at the edges of the difference array will “match” and thus not cause negative side-effects when the FFT is performed. In other words, the FFT may view the differing edges of the image to be “hard” edges if they do not match (or closely match). The windowing approach can thus allow for a more “accurate” representation of the signal that is contained within the values of the difference array as it can provide a view of the data that results in the otherwise “hard” edges of the data being smoothed out.

At 220, the windowed real values of the difference array are transformed into the frequency domain. For example, the windowed difference array may be transformed into the frequency domain by taking the Fourier Transform (e.g., using a Fast Fourier Transform) of the real numbers. Accordingly, for example, a two dimensional array of real numbers (e.g., 128×128) will then produce a similar two dimensional array of complex numbers (e.g., 128×128) that represents the frequency domain of the difference in spatial data contained in the windowed difference array.

The resulting translation to the frequency domain (e.g., by using the FFT) may be applied along the horizontal, along the vertical, or both the horizontal and vertical of the difference array. While the embodiments discussed herein may use an FFT to translate the original domain (e.g., a spatial domain) data into a frequency domain, other types of transforms (e.g., frequency based transforms) may also be used. For example, other Fourier Transforms may be used (e.g., other than FFT). In some embodiments, wavelet or cosine transforms may be used in addition to or instead of an FFT.

Note that in the case of applying an FFT to data in connection with SBTs as discussed in the '950 application, block sizes of sufficient size for signal processing may be used. Thus, for example, multiple 4×4 blocks of 4×4, 8×8 may be selected and an FFT may be used across a larger block. Thus, for example, multiple adjacent outputs block of 16×16 pixels (e.g. 8×8 blocks for a total image size of 128×128 pixels) may be selected and a FFT may be used across this larger block.

In certain examples, the ordering of when the FFT is performed may be adjusted. For example, the FFT of the predicted and target image maybe calculated and then the difference may be determined. Thus, 220 may be performed prior to 216 (with the windowing function also be applied prior to the FFT calculation). It will be appreciated, however, that performing the FFT after taking the difference may be more computationally beneficial as the FFT is only performed once (on the windowed difference array) instead of twice (on the windowed values of each image). The ordering may be adjusted due to the fact that the FFT is a linear operator and thus the following function:

$$LossFunction = \frac{{\sum }_{i = 1}^{n} \vert FFT ( {Image}_{true} ) - FFT ( {Image}_{predicated} ) \vert}{n}$$

Achieves the same mathematical result as:

$$LossFunction = \frac{{\sum }_{i = 1}^{n} \vert FFT ( {Image}_{true} - {Image}_{predicated} ) \vert}{n}$$

In certain example embodiments, the L1 norm is calculated on both the FFT of the predicated image and the FFT of the target image then another L1 is calculated on their difference.

$$LossFunction = \frac{{\sum }_{i = 1}^{n} \vert \vert FFT ( {Image}_{true} ) \vert - \vert FFT ( {Image}_{predicated} ) \vert \vert}{n}$$

Note that this example embodiment, the resulting calculation may end up discarding any phase differences in the phase of the complex numbers resulting from the FFT.

In some example embodiments, the output of the absolute value the frequency transformed data—e.g.,

|FFT(Image_{true)|}

Is the modulus of the complex number that results from performing the Fourier Transform.

Where n relates to the number of pixels and i is each pixel. In certain examples, the result of the loss function is a singular/scalar value. In other words, as shown in the above equation, it may be the sum of the absolute values (or in the case of complex numbers, the modulus or the magnitude of the complex number) of the FFT of the differences divided by the number of pixels. Another way to view the calculation of the Loss Function (which may also be called an error value, loss value, or the like herein) may be that the Loss Function is based on (a) calculating at least one Fourier Transform (e.g., an FFT), and (b) calculating a difference between the predicted image data and the target image data. As noted above, this calculated difference may be taken from the Fourier Transformed image data of both the target image and predicted image or the calculated difference may be based on the raw pixel data, which may then be Fourier Transformed. In either case, the result that is calculated (e.g., which may also include summing the results of each pixel and averaging) may be the same (e.g., due to the linear nature of FFT operations).

Returning to FIG. 2, at 222, the L1 Norm of the absolute value of each coefficient in the two dimensional array of complex numbers is taken.

At 224, the process determines, based on how small the L1 Norm of the FFT of the windowed difference is and/or whether the quality of the predicted image has stopped evolving (e.g., it is below a threshold amount), if the neural network has converged. If the neural network has converged then the resulting neural network 112 may be considered trained and provided to external users (e.g., users of game device 300).

If the neural network has not converged then, at 226, the calculated loss is used to perform back propagation on the weights and other values of the neural network. For example, the weights of the neural network are updated by using, for example, gradient decedent that uses the derivative of the loss function that is measured at the data points of the training data set.

The process returns to 210 where the training process resumes with new input data 206, possibly a new learning rate via 212, and new target output data 208.

The training process is repeated until this convergence is reached. For example, the training process is repeated until the error is within threshold error value or there has not been any decrease of the error value for more than a threshold number of iterations.

In certain example embodiments, the loss that the neural network is trained on includes the L1 loss. In other words, the training of the neural network may seek to minimize the L1 loss of the different data that has been process with a Fast Fourier Transform (or other frequency transform).

In certain example embodiments, using the L1 loss of the FFT of the windowed difference may advantageously provide sparsity to the data that is being processed by the neural network. In certain examples, training a neural network in this manner (e.g., using the L1 loss of the FFT'd data) may result in upscaled images that look sharper than other techniques (e.g., by using, for example, the L1 loss or the L2 loss of the image data).

In certain example embodiments, losses other than L1 may be used in combination with the FFT loss or instead of the FFT loss. For example, the neural network may be trained on a combination of FFT loss and the loss represented by a Generative Adversarial Network and/or a Perceptual loss. In certain example embodiments, different epochs of the neural network training may be trained on different losses. For example, a first part of training may be use an L1 loss that is trained on the image data (e.g., without using a FFT). Then, after one or more training epochs, the training may switch to using the L1 of the data that has been subject to an FFT. This approach may help, in certain instances, at jump starting the training of the neural network. In certain examples, different loss combinations may be used at different epochs of training. For example, the L1 loss of the FFT may be used initially and then the GAN loss may be added after a threshold number of epochs has been reached. In some embodiments, the different losses may be gradually blended in or out. For example, the training of a neural network may start with an L1 loss (not based on the FFT) in combination with the described FFT loss. The L1 loss may be gradually removed from the loss calculation that is used in connection with training the neural network. In some embodiments, different weights may be assigned to the various losses in this calculation. Such weights may be adjusted during the training process.

In certain example embodiments, loss functions other than a strict L1 loss function may be used during training of the neural network. For example, Lp loss functions may be used where p is any real number (e.g., between 0, or 0.1, and 1.99, etc.). As an example, a loss function of L0.99 may be used. As used herein, the term L1 family (including “L1 loss family” or “L1 family norm” and other similar terms) includes Lp loss functions between L0 and L1.5. Lp loss functions that may be “substantially similar” to a strict L1 loss function include loss functions in the range of L0.9 and L1.1.

### Description of FIG. 3

FIG. 3 is a block diagram that includes an example computer system (e.g., a game device) according to certain example embodiments.

Game device 300 is an example of computing device 700 that is shown in FIG. 7. An example of game device 300 includes game device 100 from the '950 Application. While the term “game” device is used in connection with certain example embodiments herein, this is done for ease of use and any type of computing device may be used. Indeed, a “game” device as used herein may be a computing device (e.g., a mobile phone, tablet, home computer, etc.) that is being used (or will be used) to play a video game. A non-limiting illustrative list of computing devices may include, for example, a smart or mobile device (e.g., a smart phone), a tablet computer, a laptop computer, a desktop computer, a home console system, a video game console system, a home media system, and other computer device types. As explained in connection with FIG. 7, computers can come in different sizes, shapes, functionality and the like. In certain example embodiments, the techniques discussed herein can be used in conjunction with non-game applications. For example, they may be used in conjunction with real- time video surveillance, web browsing, speech recognition, or other applications where transforming one dataset into another may be of use. Additional examples and applications for the techniques herein as discussed below.

Game devices 300 may include a CPU 302, a GPU 306, and DRAM (dynamic random-access memory) 304. CPU 302 and GPU 306 are examples of processor 702 from FIG. 13. DRAM 304 is an example of memory devices 704 from FIG. 7. Different types of CPUs, GPUs, DSPs, dedicated hardware accelerators (e.g., ASICs), FPGAs and memory technology (both volatile and non-volatile) may be employed on game device 300.

Examples of different types of CPUs include an Intel CPU architecture (e.g., x86) and an ARM (Advanced Risk Machine) architecture. Examples of different GPUs include discrete GPUs like the NVIDIA V100 (which may include hardware support for matrix multiplications or tensor cores/accelerators) and integrated GPUs that may be found on a system on a chip (SoC). SoCs may combine two or more of the CPU 302, GPU 306, and local memory like registers, shared memory or cache memory (also called static RAM or SRAM) onto a single chip. DRAM 304 (also called dynamic RAM) is usually produced as a separate piece of semiconductor and connected to the SoC through wires. For example, the NVIDIA Tegra X1 SoC includes multiple CPUs, a GPU, Northbridge controller, Southbridge controller, and a memory controller all onto a single SoC. In certain examples, the processing capabilities provided by the CPU, memory components, GPU, and/or other hardware components that make up a given game device may be different than other game devices. Some game devices may be mobile, some may be stationary game consoles, or operate as personal computers (e.g., a desktop or laptop computer system that is used to play video games).

Game device 300 may be coupled to input device 314 and display device 316. Examples of input device 314 include video game controllers, keyboards, mice, touch panels, sensors and other components that may provide input that is used by the computer system (e.g., game device) to execute application programs and/or video games that are provided thereon. Examples of display device 316 include televisions, monitors, integrated displays (e.g., that is part of a mobile phone or tablet), and the like.

Game device 300 stores (e.g., in volatile or non-volatile storage) and executes a video game application program 308. Included in the video game application program are a game engine 310 and a neural network 312. Neural network 312 may be a neural network trained as discussed in connection with FIGS. 1 and/or 2 and has been distributed to game device 300 for use with video game application program 308. The game device 300 may also store image data (e.g., textures) and other types of assets (e.g., sound, text, pre-rendered videos, etc.) that are used by the video game application program 308 and/or game engine 310 to produce or generate content for the video game (or other application) such as, for example, images for the game. Such assets may be included with a video game application program on a CD, DVD, or other physical media, or may be downloaded via a network (e.g., the Internet) as part of, for example, a download package for the video game application program 308.

The game engine 310 includes program structure for generating images that are to be output to the display 316. For example, the game engine 310 may include program structure for managing and updating the position of object(s) in a virtual space based on inputs provided from the input device 314. The provided data is used to render or generate an image of the virtual space by using, for example, a virtual camera. This image may be a source image that is generated in a first resolution (e.g., 540p). The source image may then be applied as an input to neural network 312 that converts the source image into an upconverted image (e.g., an upconverted image is generated based on application of the source image to the neural network 312) that is at a higher resolution (e.g., 1080p) than the original source image. That upconverted image may then be output to the display device 316 for display thereon.

It will be appreciated that while the techniques herein are discussed in connection with upscaling images to a higher resolution, that the techniques herein may also be applied to generating images of the same resolution. For example, images that have anti-aliasing or other visual effects may be generated via a neural network that has been trained for such effects. Additional details on upconversion or conversion processes that may be performed on game device 300 are described in U.S. application Ser. No. 16/829,950.

In certain examples, game device 300 may be configured to couple with or work with different types of display devices. For example, game device 300 may be coupled to an integrated display (e.g., that is part of the structural body that houses game device 300) on which images may be output. Game device 300 may also be configured to output images to a larger television or other display. In certain example embodiments, the different display devices may natively display different resolutions. For example, the integrated display of a game device may have 0.5 million pixels (e.g., a 540p display) and the separate display may have 2.1 million pixels (e.g., a 1080p display). In certain examples, one display may have a 720p display, and another display may have a 1080p or 4k display.

Using the techniques herein, the game device 300 may be configured to output different images for the same game depending on what display device is the target for the game device. Thus, for example, 540p images will be output to the integrated 540p display when the integrated display is used and 1080p images may be output to the 1080p display when it is used. In certain example embodiments, two different images may be output at the same time, with one being the image generated by the game engine and the other generated based on processing by the neural network. For example, the lower resolution image may be output to a local display on a handheld device and the higher resolution image may be output to a higher resolution television of computer monitor. Such implementations may advantageously allow two displays to be used at the same time for playing the game. This may allow, for example, two different users to play the same game on different screens.

In certain example embodiments, the game device 300 may dynamically switch between the type of images that are being output based on the conditions associated with the game device 300. Such switching may occur while a game is being played by a user (with perhaps a brief pause while the switch between the two modes occurs). For example, if game device 300 is running on battery (e.g., is not plugged in to a wall socket), then game device 300 may be configured to not use an example image conversion process that uses the techniques discussed herein. However, if the computer system is plugged into a wall socket or the like, then the techniques discussed herein for upconverting images to a higher resolution may be used or turned on for a video game or other application. This is because the techniques discussed herein may increase the power consumption of the GPU due to using a greater percentage of the processing power that is available to the GPU being used (e.g. up to 80, 90, or 95% or greater). Thus, if the computer system were to run solely off the battery of the mobile device while using, for example, the process shown in FIG. 2 of U.S. application Ser. No. 16/829,950, it may more quickly deplete the battery.

Such techniques may thus allow a user to play a game on a mobile device as they are, for example, commuting home from work. In this mode the user would use the local display on the device (e.g., at 540p or 720p) for the video game. However, when the user gets home they may plug the mobile device into a wall socket or other dedicated power so that it is no longer relying on the battery power of the mobile device. Similarly, the user may couple the mobile device to a larger display (like a television) that is a 1080p or 4k display (e.g., higher resolution than the mobile device display). Such a connection may be wired (e.g., a DisplayPort or HDMI cable) or wireless (e.g., Bluetooth or WiFi).

Upon detecting one (or both) of these scenarios (e.g., the target display being able to display a higher resolution and/or a non-battery power supply for the computing system), the system may dynamically start the image conversion process that uses a trained neural network to allow a user to play a game on their 1080p (or other resolution) television and see the game in a higher resolution. In certain example embodiments, the user may manually start the process of image upconversion as well.

### Description of FIGS. 4A-5

FIGS. 4A-5 show different example images, in color, used or produced in connection with techniques described herein. Each of the images is of green grass, with FIG. 5 including zoomed in areas of one blade of green grass.

Each pixel within each image in FIGS. 4A-5 may be represented by different color values in RGB. The pixel values that are used in connection with the techniques herein (e.g., to calculate the difference) may thus be the RGB pixel values associated with each respective pixel. It will be appreciated that other types of data may be stored for each pixel. For example, the techniques herein may also be used in connection with grey scale images where each pixel stores an amount of “light” for that pixel. In certain example embodiments, color information may be processed/provided by using YUV or YCoCg formats. In certain example embodiments, the luminance (Y) channel may be used with the techniques discussed herein and thus processed (e.g., upscaled) using Neural Networks.

FIG. 4A shows an example of a lower resolution input image 400 that may be used in connection with training a neural network with the computer system of FIG. 1 or using a neural network with the computer system of FIG. 3. For example, image 400 may be an image that is produced by game engine 310. Image 400 may be one that is also output a lower (relatively) resolution display. Image 400 may also be used as part of a training dataset for training a neural network as discussed in connection with FIGS. 1 and 2. For example, image 400 may be an example of an image that is generated at 204 in FIG. 2.

FIG. 4B shows an example higher resolution predicted image 410 that has been produced by training a neural network without using a Fast Fourier Transform during the training process (e.g., that was trained with an L1 loss). Note that the resulting image includes areas 412 and 414 of unstructured noise. The resulting image also includes a more jagged representation of the blade of grass on the left side of the image (when compared to image 420 of the same blade of grass in FIG. 4C). The section of the grass at 412 shows that the blade of grass includes a similar staircase representation of the grass as is found in low resolution image 400.

FIG. 4C shows a higher resolution predicted image 420 produced by training a neural network by using a Fast Fourier Transform according to certain example embodiments. Image 420 is an example of an image that may be produced during training of a neural network by computer system computer system 100 of FIG. 1 or the process discussed in FIG. 2, and/or output after being processed by neural network 312 of game device 300 in FIG. 3. Image 420 may be an image that is generated by processing image 400 by using the trained neural network 112.

A way to view the transformation process of the upscaled image is that taking the FFT of the image data (or the difference) assists in determining where lines are located within the image (e.g., where there are relatively sharp transitions in the signal). For example, the lines represented by the blades of grass shown in FIG. 4C.

As shown in FIG. 4C, the generated image 420 includes Gibbs or Ringing Artifacts at areas 422. These artifacts may appear within the generated image near areas of transition within the image (e.g., where the image transitions from the blade of grass to the background). Such artifacts can appear within the resulting image as bands or ghosts near edges that are located within the image.

While such Gibbs artifacts may be viewed potentially as a negative side-effect, their presence in images that are being displayed at, for example, 24, 30, or 60 frames per second (or other rates at which frames may be output and/or displayed), may be advantageous as the ringing effect may have the effect of increasing the sharpness (or apparent sharpness) of the image to the user.

FIG. 5 shows side-by-side views of a blowup portions 400B, 410B, and 420B, from, respectively, images 400, 410, and 420. The blown up areas in FIG. 5 are from the tip of the blade of grass on each of the three different images in FIGS. 4A-4C. Image 410B is an example of an image (or a portion thereof) that is produced by using an example trained neural network 112.

The processing techniques discussed herein for training neural networks may also be applied to compression or coding domains. In certain example embodiments, the techniques herein may be used to generate an autoencoder, which may be composed of a neural network that encodes input, and a neural network that decodes the input that has been encoded. For example, a neural network (e.g., a first neural network) may be trained to compress original image data into a smaller data size (e.g., a file, latent file or data). Another neural network (e.g., a second neural network and/or a part of the autoencoder) may then be trained to decompress the data back into the image (or an image that is sufficiently similar to the original). This second neural network may be, in some examples, the reverse or a mirror of the first neural network.

In some embodiments, a computer system is provided that comprises: (a) non-transitory computer-readable storage configured to store a trained neural network and instructions of a video game program; and (b) a processing system that includes at least one hardware processor. The processing system is configured to: execute the video game program; generate, by using a rendering engine of the video game program, images that are at a first resolution; apply the generated images to the trained neural network to produce images that are at a second resolution, which is higher than the first resolution, wherein the images produced at the second resolution include Gibbs or ringing artifacts that are not included in the images that are produced at the first resolution; and output, to a display that is coupled to the processing system, the images that have been produced at the second resolution.

In some embodiments, the processing system is further configured to use separable block transforms when the generated images are applied to the trained neural network. In some embodiments, for each image that is generated by the rendering engine, a corresponding image at the second resolution is output within at least 1/24th of a second.

### Description of FIG. 7

FIG. 7 is a block diagram of an example computing device 700 (which may also be referred to, for example, as a “computing device,” “computer system,” or “computing system”) according to some embodiments. In some embodiments, the computing device 700 includes one or more of the following: one or more processors 702; one or more memory devices 704; one or more network interface devices 706; one or more display interfaces 708; and one or more user input adapters 710. Additionally, in some embodiments, the computing device 700 is connected to or includes one or more display devices 712. Additionally, in some embodiments, the computing device 700 is connected to or includes one or more input devices 714. In some embodiments, computing device 700 may be connected to one or more external devices 716. As will explained below, these elements (e.g., the processors 702, memory devices 704, network interface devices 706, display interfaces 708, user input adapters 710, display devices 712, input devices 714, external devices 716) are hardware devices (for example, electronic circuits or combinations of circuits) that are configured to perform various different functions for and/or in conjunction with the computing device 700.

In some embodiments, each or any of the processors 702 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes, for example, a CPU, a GPU, and other hardware components such as memory and/or a memory controller (e.g., Northbridge), I/O controller (e.g., Southbridge), networking interfaces, and the like). In some embodiments, each or any of the processors 702 uses an instruction set architecture such as x86 or Advanced RISC Machine (ARM). In some embodiments, each or any of the processors 702 is or includes, for example, a graphical processing unit (GPU), which may be an electronic circuit designed to generate images and the like. One or more of the processors 702 may be referred to as a processing system in certain examples.

In some embodiments, each or any of the memory devices 704 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions that may be executed by one or more of the processors 702), or other type of device that performs the volatile or non-volatile storage of data and/or instructions (e.g., software that is executed on or by processors 702). Memory devices 704 are an example of non-transitory computer-readable storage.

In some embodiments, each or any of the network interface devices 706 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (e.g., IEEE 802.11), GSM, CDMA2000, UMTS, LTE, LTE-Advanced (LTE-A), and/or other short-range (e.g., Bluetooth Low Energy, RFID), mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 708 is or includes one or more circuits that receive data from the processors 702 (e.g., via a discrete GPU, an integrated GPU, a CPU executing graphical processing, or the like) that are used to generate corresponding image data based on the received data, and/or output (e.g., a High-Definition Multimedia Interface (HDMI), a DisplayPort Interface, a Video Graphics Array (VGA) interface, a Digital Video Interface (DVI), or the like) the generated image data to the display device 712, which displays the image data thereon. Alternatively or additionally, in some embodiments, each or any of the display interfaces 708 is or includes, for example, a video card, video adapter, or graphics processing unit (GPU). In other words, the each or any of the display interfaces 708 may include a processor therein that is used to generate image data. The generation or such images may occur in conjunction with processing performed by one or more of the processors 702.

In some embodiments, each or any of the user input adapters 710 is or includes one or more circuits that receive and process user input data from one or more user input devices (714) that are included in, attached to, or otherwise in communication with the computing device 700, and that output data based on the received input data to the processors 702. Alternatively or additionally, in some embodiments each or any of the user input adapters 710 is or includes, for example, a PS/2 interface, a USB interface, a touchscreen controller, or the like; and/or the user input adapters 710 facilitates input from user input devices 714.

In some embodiments, the display device 712 may be a Liquid Crystal Display (LCD) display, Light Emitting Diode (LED) display, or other type of display device. In embodiments where the display device 712 is a component of the computing device 700 (e.g., the computing device and the display device are included in a unified housing), the display device 712 may be a touchscreen display or non-touchscreen display. In embodiments where the display device 712 is connected to the computing device 700 (e.g., is external to the computing device 700 and communicates with the computing device 700 via a wire and/or via wireless communication technology), the display device 712 is, for example, an external monitor, projector, television, display screen, etc...

In some embodiments, each or any of the input devices 714 is or includes machinery and/or electronics that generates a signal that is provided to the user input adapter(s) 710 in response to physical phenomenon. Examples of inputs devices 714 include, for example, a keyboard, a mouse, a trackpad, a touchscreen, a button, a joystick, a sensor (e.g., an acceleration sensor, a gyro sensor, a temperature sensor, and the like). In some examples, one or more input devices 714 generate signals that are provided in response to a user providing an input—for example, by pressing a button or actuating a joystick. In other examples, one or more input devices generate signals based on sensed physical quantities (e.g., such as force, temperature, etc.). In some embodiments, each or any of the input devices 714 is a component of the computing device (for example, a button is provide on a housing that includes the processors 702, memory devices 704, network interface devices 706, display interfaces 708, user input adapters 710, and the like).

In some embodiments, each or any of the external device(s) 716 includes further computing devices (e.g., other instances of computing device 700) that communicate with computing device 700. Examples may include a server computer, a client computer system, a mobile computing device, a cloud-based computer system, a computing node, an Internet of Things (IoT) device, etc. that all may communicate with computing device 700. In general, external devices(s) 716 may include devices that communicate (e.g., electronically) with computing device 700. As an example, computing device 700 may be a game device that communicates over the Internet with a server computer system that is an example of external device 716. Conversely, computing device 700 may be a server computer system that communicates with a game device that is an example external device 716.

In various embodiments, the computing device 700 includes one, or two, or three, four, or more of each or any of the above-mentioned elements (e.g., the processor(s) 702, memory device(s) 704, network interface device(s) 706, display interface(s) 708, user input adapter(s) 710, display device(s) 712, input device(s) 714). Alternatively or additionally, in some embodiments, the computing device 700 includes one or more of: a processing system that includes the processors 702; a memory or storage system that includes the memory devices 704; and a network interface system that includes the network interface devices 706.

The computing device 700 may be arranged, in various embodiments, in many different ways. As just one example, the computing device 700 may be arranged such that the processors 702 include: a multi (or single)-core processor; a first network interface device (which implements, for example, WiFi, Bluetooth, NFC, etc.); a second network interface device that implements one or more cellular communication technologies (e.g., 3G, 4G LTE, CDMA, etc.); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 700 may be arranged such that: the processors 702 include two, three, four, five, or more multi-core processors; the network interface devices 706 include a first network interface device that implements Ethernet and a second network interface device that implements WiFi and/or Bluetooth; and the memory devices 704 include a RAM and a flash memory or hard disk. As another example, the computing device 700 may include a SoC with one or several processors 702, plural network interface devices 706, memory devices 704 that include system memory and memory for application programs and other software, a display interface 708 that is configured to output a video signal, a display device 712 that is integrated to a housing with the mentioned and layered with a touch screen input device 714, and multiple input device 714 such as one or more joysticks, one or more buttons, and one or more sensors.

As previously noted, whenever it is described in this document that a software module or software process performs any action, the action may be performed by the underlying hardware elements according to the instructions that comprise the software module.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

Techniques for training neural networks to convert and/or upscale images are described that advantageously result in an improved resulting image quality. For example, the quality may be suitable for converting 540p or 720p images to 1080p or 4k images that are displayed to a user. The quality improvement is at least partly based on using a frequency transform on the image data (or the difference in image data) when neural network training is being performed. Such quality improvements may be with respect to those over neural networks trained on conventional L1 or L2 losses.

In some embodiments, the resulting neural network that is trained according to the techniques described herein may be used to produce images that include Gibbs or ringing artifacts. The generation of such images during gameplay of, for example, a video game can provide for improved user experiences when viewing images that have been converted into higher resolutions from the “native” resolution that is output from, for example, game engine.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used to provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

Additional Applications of Described Subject Matter

Although process steps, algorithms or the like, including without limitation with reference to FIGS. 1-3, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system for training a neural network that processes images, the computer system comprising:
non-transitory computer readable storage configured to store image data for a plurality of images;
at least one hardware processor that is coupled to the non-transitory computer readable storage, the at least one hardware processor configured to:
generate, from the plurality of images, input image data and target image data;
generate predicted output image data by using the input image data as input to a neural network;
calculate a difference between the predicted output image data and the target image data;
transform the calculated difference into frequency domain data;
calculate a loss value using an L1 family norm of the frequency domain data; and
as part of training the neural network, perform backpropagation on the neural network to update weights of the neural network based on the calculated loss value.

2. The computer system of claim 1, wherein the transformation of the calculated difference into frequency domain data is performed by using a Fourier Transform.

3. The computer system of claim 1, wherein the input image data represents images of a first resolution, and the target image data represents images of a second resolution.

4. The computer system of claim 1, wherein the at least one hardware processor is further configured to:
apply, as part of transformation of the calculated difference, a windowing function to the calculated difference, wherein transformation of the calculated difference into frequency domain data is further based on application of the windowing function to the calculated difference.

5. The computer system of claim 1, wherein the at least one hardware processor is further configured to:
control, as part of the training of the neural network, a learning rate over at least a first portion and a second portion, which occurs after the first portion, of the training of the neural network;
during the first portion, the learning rate is increased; and
during the second portion, the learning rate is decreased.

6. The computer system of claim 5, wherein a rate of change of the learning rate during the first portion is greater than a rate of change during the second portion.

7. The computer system of claim 1, wherein the loss value is a scalar value that is calculated based on (a) a sum of the frequency domain data of differences in pixel values of different pixel locations within the target and output image data, and (b) a total number of differences in pixel values.

8. The computer system of claim 1, wherein the neural network is implemented using separable block transforms.

9. The computer system of claim 1, wherein the L1 family norm is the L1 norm.

10. A method of training a neural network to process image data, the method comprising:
storing, to non-transitory computer readable storage, image data for a plurality of images;
generating predicted output image data by using the input image data as input to a neural network;
calculating a difference between the predicted output image data and target image data;
transforming the calculated difference into frequency domain data;
calculating a loss value using an L1 family norm of the frequency domain data; and
as part of training the neural network, performing backpropagation on the neural network to update weights of the neural network based on the calculated loss value.

11. The method of claim 10, wherein the transformation of the calculated difference into frequency domain data is performed by using a Fourier Transform.

12. The method of claim 10, wherein the input image data represents images of a first resolution, and the target image data represents images of a second resolution.

13. The method of claim 10, further comprising:
applying, as part of transforming the calculated difference, a windowing function to the calculated difference, wherein transformation of the calculated difference into frequency domain data is further based on application of the windowing function to the calculated difference.

14. The method of claim 10, further comprising:
controlling, as part of the training of the neural network, a learning rate over at least a first portion and a second portion, which is occurs after the first portion in the training of the neural network, of the training of the neural network;
during the first portion, increasing the learning rate; and
during the second portion, decreasing the learning rate.

15. The method of claim 14, wherein a rate of change of the learning rate during the first portion is greater than a rate of change during the second portion.

16. The method of claim 10, wherein the loss value is a scalar value that is calculated based on (a) a sum of the frequency domain data of differences in pixel values of different pixel locations within the target and output image data, and (b) a total number of differences in pixel values.

17. The method of claim 10, wherein the neural network is implemented using separable block transforms.

18. The method of claim 10, wherein the L1 family norm is the L1 norm.

19. The method of claim 10, further comprising:
as part of calculating the difference between the predicted output image data and target image data, calculating a difference in RGB pixel values between at least one pixel in the target image data and a corresponding pixel in the predicted output image data; and
storing the calculated differences to a two-dimensional array,
wherein transforming the calculated difference includes performing a Fourier Transform on the two-dimensional array as part of obtaining the frequency domain data.

20. A computer system for training a neural network that processes images, the computer system comprising:
non-transitory computer readable storage configured to store image data for a plurality of images;
at least one hardware processor that is coupled to the non-transitory computer readable storage, the at least one hardware processor configured to:
generate, from the plurality of images, input image data and target image data;
generate predicted output image data by using the input image data as input to a neural network;
transform the target image data and output image data into, respectively, frequency domain target data and frequency domain output data;
calculate the absolute value of each coefficient of the frequency domain target data and the frequency domain output data;
calculate a loss value by using a difference between each respective coefficient of the absolute value of the frequency domain target data and the absolute value of the frequency domain output data; and
as part of training the neural network, perform backpropagation on the neural network to update weights of the neural network based on the calculated loss value.
